(19) United States
(12) Patent Application Publication
(10) Pub. No.: US 2017/0286519 A1
(43) Pub. Date: Oct. 5, 2017

(54) SYNCHRONIZING DATA MODIFICATIONS BASED ON TIME ZONES

(71) Applicant: SAP SE, Walldorf (DE)

(72) Inventors: VLADIMIR BAZARSKY, REDWOOD CITY, CA (US); MURALI MAZHAVANCHERY, SAN FRANCISCO, CA (US); PAUL BRIMBLE, YELVERTON (GB); SIRISHA AYYAGARI, FOSTER CITY, CA (US); MICHAEL ROSSI, LADERA RANCH, CA (US); AYYAPPA ANANTAPALLI, SAN RAMON, CA (US)

(21) Appl. No.: 15/090,677

(22) Filed: Apr. 5, 2016

(51) Int. Cl. G06F 17/30

(52) U.S. Cl. CPC G06F 17/30581; G06F 17/30368

(57) ABSTRACT

Methods and system are disclosed that synchronize data modifications. In one aspect, a data modification model may determine modifications of data in a table (e.g., first table) associated with a time zone (e.g., first time zone). The data modification model may determine other tables (e.g., second table, third table, etc.) to which the modifications of the data may be propagated. The other tables may be associated with one or more time zones (e.g., second time zone, third time zone, etc.). A time offset model may be executed to calculate time offset values between the time zones and a time standard. Based on the calculated time offset values, an effective date to execute a data synchronization model may be determined. The data synchronization model may be executed on the determined effective date to propagate or synchronize the modifications of data between the tables.

### BACKGROUND

Enterprise data may be scattered and stored in different formats in geographically distributed databases. The modifications in the enterprise data may need to be synchronized between the geographically distributed databases. Since the enterprise data is stored in geographically distributed databases, the databases may be associated with time offsets between different time zones. When the modifications in the enterprise data is synchronized without including determining the time offsets and the time when the respective databases are scheduled to synchronize the modifications in the enterprise data, the enterprise data may be inconsistent.

For example, when enterprise data stored on a database in San Francisco is modified at 16:00 hours pacific standard time (PST) of a business day and such modifications are scheduled to be synchronized at 00:00 hours PST (e.g., midnight of the business day), the modifications of the enterprise data may be available in Shanghai, China, only at 16:00 hours China Standard Time (CST), which would be the next business day, because of the time offset between PST and CST. Therefore, determining time offset values between the different time zones and determining when to synchronize or propagate the modifications of enterprise data, may be challenging.

### SUMMARY

In some implementations, methods and apparatus, including computer program products, are provided for synchronizing data modifications based on time zones.

In one aspect, a data modification model is executed to determine one or more modifications of data in a first table associated with a first time zone. The data modification model is further executed to determine one or more tables for propagating the one or more modifications of the data. The one or more tables are associated with one or more second time zones. Based on the first time zone and the one or more second time zones, a time offset model is executed to calculate one or more time offset values. Based on the calculated one or more time offset values, a data synchronization model is executed to synchronize the one or more modifications of the data in the one or more tables.

The above methods, apparatus, and computer program products may, in some implementations, further include one or more of the following features.

One or more first time offset values can be calculated based on the first time zone and the one or more second time zones. One or more second time offset values can be calculated based on a time standard and the calculated one or more first time offset values.

Executing the time offset model can further include determining an effective date to execute the data synchronization model for synchronizing the one or more modifications of the data in the one or more tables.

Executing the data synchronization model can further include filtering, based on the determined effective date, one or more datasets from the one or more tables for propagating the one or more modifications of the data.

When execution of the data synchronization model is successful, consistency of propagation in the one or more modifications of the data in the one or more tables can be determined.

Upon determining that the execution of data synchronization model is unsuccessful, a resynchronization model can be executed to propagate the one or more modifications of the data in the one or more tables.

Executing the resynchronization model can include determining the one or more datasets that failed to include the propagated one or more modifications in the one or more tables; determining the one or more second time zones associated with the one or more determined datasets that failed to include the propagated one or more modifications in the one or more tables; based on the determination, configuring the execution of data synchronization model; and, upon configuring, executing the data synchronization model to propagate the one or more modifications in the one or more datasets that failed to include the one or more modifications.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating environment to synchronize modifications of data, according to an embodiment.

FIG. 2 is a flow diagram illustrating process to synchronize modifications of data, according to an embodiment.

FIG. 3 is a flow diagram illustrating process for executing a time offset model, according to an embodiment.

FIG. 4 is a flow diagram illustrating process for executing a resynchronization model, according to an embodiment.

FIG. 5 is a block diagram of a computer system, according to an embodiment.

### DETAILED DESCRIPTION

Embodiments of techniques related to synchronizing data modifications based on time zones are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Data in an enterprise may be accessed and modified by multiple systems and applications and stored in geographically distributed data repositories (e.g., data stores, databases, etc.). The multiple systems and applications accessing such data may be deployed on different platforms (e.g., on premise environment, cloud computing environment, etc.) in the enterprise. In an embodiment, modifications (e.g., edit, delete, update, add) of the data may need to be synchronized with the data stored in the geographically distributed data repositories. In an embodiment, the modifications in the data stored in geographically distributed data repositories may be propagated based on a decision logic. The decision logic may include calculating time offset values between the different geographical locations based on a time zone, a standard time, etc. In an embodiment, a time zone may correspond to a region that may observe or follow a standard time for legal and commercial purposes. The time zones may have an offset value (e.g., a positive offset value, a negative offset value, etc.) from a standard time (e.g., universal standard time—Coordinated Universal Time (UTC)).

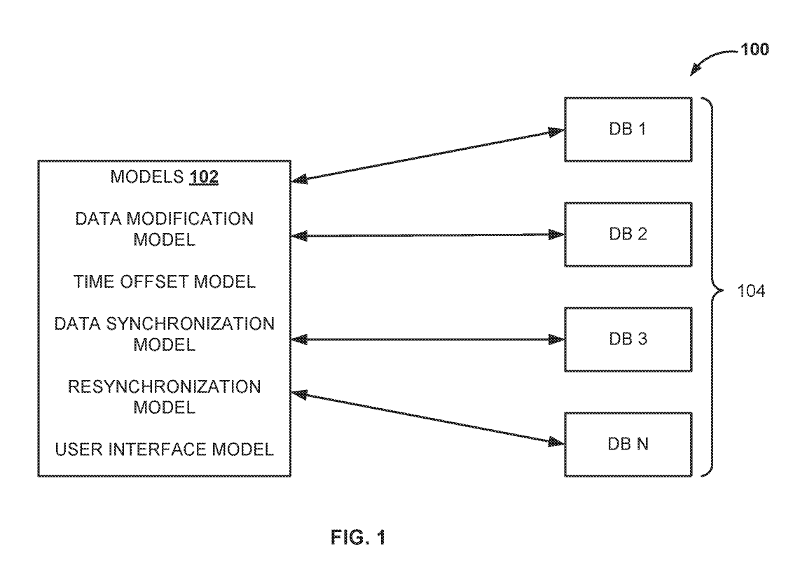

FIG. 1 is a block diagram illustrating environment 100 to synchronize modifications of data, according to an embodiment. In an embodiment, FIG. 1 shows an environment 100 including data models 102 in communication with data repositories 104 (e.g., DB 1, DB 2, DB 3, DB N—databases, data stores, etc.). The data repositories 104 may be deployed in different time zones and may store data associated with an enterprise. The data in the data repositories 104 may be stored in data structures (e.g., tables, flat files, etc.). In an embodiment, data models 102 may include a data modification model, a time offset model, a data synchronization model, a resynchronization model, a user interface model, etc. Data models 102 may trigger, instantiate and work in conjunction with each other to synchronize modifications of data between data repositories 104.

In an embodiment, data models 102 may also be modeled as software components, routines, algorithms (e.g., sequence of program instructions executed by multiple processors in multiple systems), etc. In an embodiment, a software component may correspond to set of instructions or program code that may be reused based on definition and implementation. For example, the software components may instantiate execution of algorithms for executing operations like calculating time offset values, synchronizing modifications of the data between data repositories 104, filtering and aggregating datasets based on an effective date for synchronizing the modifications of the data, determining datasets that failed to synchronize the modifications of data, resynchronizing the modifications of data, etc.

In an embodiment, data models 102 may work in conjunction with a data repository management system (not shown) associated with each data repository (e.g., DB 1, DB 2, DB 3, DB N, etc.). In an embodiment, execution of the data modification model may determine or detect modifications of data in data repositories 104. The data modification model may include a routine to monitor the data in data repositories 104 and may determine modifications in the data. In an embodiment, execution of the time offset model may generate tables and associated time zones (e.g., data repositories 104 storing data associated with multiple time zones) in which the data modifications may be propagated, calculate time offset values between multiple time zones, standard time (e.g., UTC), determine an effective date for executing the data synchronization model to propagate the modifications of data, etc. The data synchronization model may be executed to synchronize the modifications of data between data repositories 104. The resynchronization model may be executed to determine datasets that failed to include the propagated modifications in the data and upon such determination, the datasets may be filtered, aggregated and data modifications may be propagated.

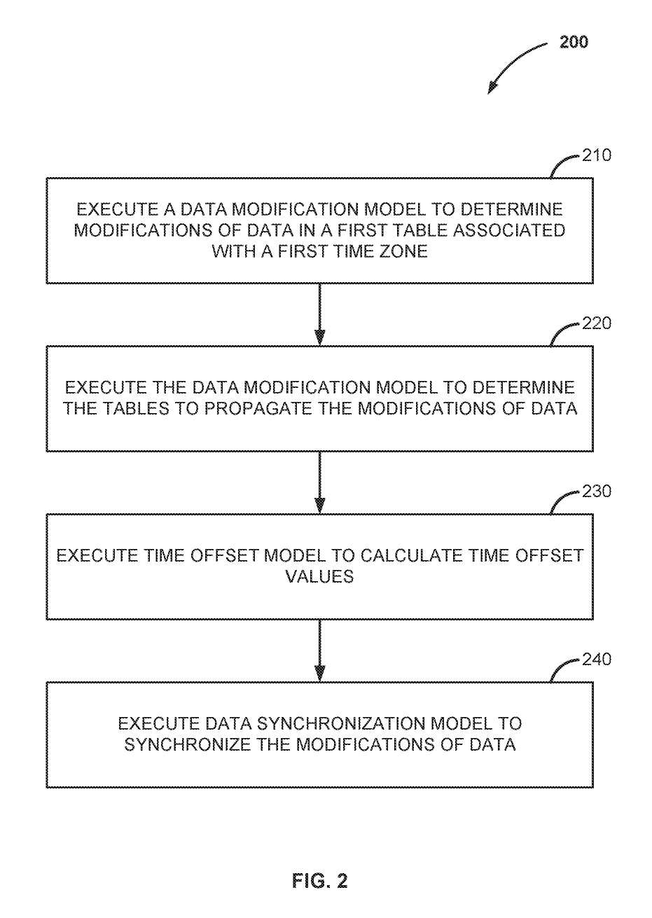

FIG. 2 is a flow diagram illustrating process 200 to synchronize modifications of data, according to an embodiment. In an embodiment, modifications of data stored in geographically distributed data stores of an enterprise may be synchronized. The data may be related to information associated with employees, multiple processes, applications, etc., of the enterprise. For example, the applications related to synchronization of modifications of data may include logistics management, inventory management in warehouses, management of financial information, etc.

In an embodiment, the data may be stored in data structures in the geographically distributed data stores and may be associated with different time zones. Some data may be identical such as, information related to employees in different geographical locations. For example, a table ‘EmpJobInfo’ may reside in a central data store and may include information related to the employees across different geographical locations (e.g., US, France, China, etc.) of the enterprise. A corresponding table ‘EmpJobInfo_Shanghai’ may reside in a data store in Shanghai, China and may include information related to the employees in Shanghai, China. In an embodiment, when the data in a table residing in a time zone (e.g., first time zone) is modified, the modifications may be propagated to other tables in the other time zones (e.g., second time zone, third time zone, etc.). In an embodiment, the modifications of the data may be determined by executing the data modification model. In an embodiment, one or more of data models 102 (e.g., a data modification model, a time offset model, a data synchronization model, a resynchronization model, etc.) may be configured to execute specific functions and trigger other data models.

In an embodiment, a data modification model is executed to determine modifications of data in a table (e.g., first table) associated with a time zone (e.g., first time zone), at 210. Upon determining the modifications, execute the data modification model to determine the tables to propagate the modifications of the data, at 220. For example, the decision logic to determine the tables to propagate the modifications of the data may include determining the attributes of the data and the data values in the table (e.g., ‘EmpJobInfo’) in which data is modified. The attributes of the data and data values in the corresponding tables (e.g., ‘EmpJobInfo_Shanghai’) to which the modifications of the data may be propagated may be determined. Upon determination, the attributes of the data may be matched and the corresponding tables are selected. In an embodiment, the corresponding tables may reside at different geographical locations and be associated with different time zones (e.g., second time zones, third time zones, etc.). The modifications in the data may be propagated or synchronized between the tables (e.g., tables in different time zones) based on a decision logic.

For example, the decision logic to synchronize the modifications of the data may include calculating time offset values by executing a time offset model. In an embodiment, a time offset model is executed to calculate time offset values, at 230. The execution of the time offset model may generate a list of tables and associated time zones in which data modifications may be propagated, calculate time offset values (e.g., first time offset values, second time offset values, etc.) based on the time offset values between the time zones (e.g., first time zone, second time zone, etc.), a standard time (e.g., UTC), etc. In an embodiment, the calculated time offset values may include a positive time offset value, a negative time offset value, a null offset value, etc. The decision rules to determine when (e.g., effective date) to execute the data synchronization model may be based on the calculated time offset values. For example, for positive time offset values, the time offset model may determine that the effective date for executing the data synchronization model as ‘tomorrow’; for negative time offset values, the effective date for executing data synchronization model may be determined as ‘today’, etc. In an embodiment, based on the determined effective dates (e.g., today, tomorrow, etc.), datasets may be filtered and aggregated. Upon filtering and aggregating the datasets, the data synchronization model may propagate the modifications of data. In an embodiment, a data synchronization model is executed to synchronize the modifications in the data in the other tables, at 240.

In an embodiment, the data modification model may be configured to work in conjunction with the time offset model. The execution of the data modification model may determine the modifications of the data in a table, determine other tables to which the modifications of the data may be propagated, trigger the time offset model, etc.

For example, let a business scenario include synchronizing the data related to employee information. Such employee information may be related to the status of employment (e.g., new hire, currently employed, promoted, terminated, etc.) associated with the employee. In an embodiment, let such employee information may be stored in a centrally accessible table ‘EmpJobInfo’ on a data store in San Francisco, US and associated with the time zone Pacific Standard Time (PST—e.g., first time zone). The table ‘EmpJobInfo’ may also store related employee information who are employed at different geographical locations. For example, a corresponding table ‘EmpJobInfo_Shanghai’ may store employee information of employees employed in Shanghai, China and associated with China Standard Time (CST—e.g., second time zone). In an embodiment, the execution of time offset model may determine that employee information is stored in the corresponding table in Shanghai, China and may filter and aggregate it on a list (e.g., list of tables and associated time zones). Further, the execution of the time offset model may determine that the time offset value (e.g., first time offset value) between PST and CST is +16 hours. The modifications in the data between the tables ‘EmpJobInfo’ and ‘EmpJobInfo_Shanghai’ may be synchronized by executing a data synchronization routine.

For example, consider that the data related to an employee employed in China is modified in the table ‘EmpJobInfo’ at 4:00 p.m. PST (e.g., 16:00 hours PST) on March 21^{st}. When data synchronizing routine is scheduled to be executed at 12:00 a.m. PST (e.g., 00:00 hours PST) on March 22^{nd}, the modifications in the data would be propagated to the table ‘EmpJobInfo_Shanghai’ at 4:00 p.m. CST (e.g., 16:00 hours CST) on March 22^{nd}, because of the time offset value between the time zones (e.g., PST and CST). In such a scenario, the modifications in the data would be propagated to the table ‘EmpJobInfo_Shanghai’ would be available only at 4:00 pm CST (e.g., 16:00 hours CST) on March 22^{nd}, which is about +8:00 hours after start of the business day in Shanghai, China (e.g., start of business day is 8:00 a.m. CST). In such a scenario, the modifications in the data may be propagated at 4 p.m. CST on March 22^{nd}, and hence the propagation in the modifications of the data may be inconsistent.

In an embodiment, such inconsistency in propagation in the modifications of the data may be eliminated by executing the time offset model, the data synchronization model, the resynchronization model, etc. The execution of time offset model may determine: time offset values (e.g., first time offset values) between the time zones, time offset values (e.g., second time offset values) between time first time offset values and a time standard, determine an effective date for execution of data synchronization model, etc.

In an embodiment, the execution of time offset model may calculate the time offset values based on the time standard (e.g., UTC), the first time zone (e.g., PST) and the second time zone (e.g., CST). For example, the first time offset values between the first time zone (e.g., PST) and the second time zone (e.g., CST) may be calculated to be equal to +16 hours (e.g., positive time offset value). The second time offset values may be calculated based on the time standard (e.g., UTC) and the first time offset values. For example, the second time offset values may be calculated by determining time offset between the first time offset value and a time offset between the time standard (e.g., UTC) and CST (e.g., +8 hours). In an embodiment, based on the second time offset values, the time offset model may generate sets of time zones that have positive time offset values and negative time offset values. Upon determining the positive or negative time offset values, the effective date for executing the data synchronization model may be determined. In the above example, since the offset value between UTC and CST is +8 hours, the time offset model may determine that the effective date for executing the data synchronization model is tomorrow (e.g., midnight of March 22^{nd}) such that the modifications of data are consistently propagated and are available at a start of next business day in Shanghai, China.

In an embodiment, the execution of data synchronization model may filter and aggregate the datasets before synchronizing the modifications of the data. The datasets may be filtered and aggregated based on the determined effective date or time offset values (e.g., positive time offset values, negative time offset values, etc.). Further, the filtered and aggregated datasets may be updated to include the modifications of data upon executing the data synchronization model. In an embodiment, the decision logic for determining the effective date for executing the data synchronization model may be based on decision rules that may be defined by the following equations:

time zone in <list-of-time-zones> and EffStartDate=today and EffEndDate>=today Equation (1):

time zone in <list-of-time-zones> and EffStartDate=tomorrow and EftEndDate>=tomorrow Equation (2):

time zone in <list-of-time-zones> and EffStartDate=today+2 and EffEndDate>today+2 Equation (3):

In the above equations, <list-of-time-zones> may include ‘TZToday’ and ‘TZTomorrow’ which may represent the time zone with an effective date ‘today’ or time zone with effective date ‘tomorrow’, respectively. The ‘today+2’ may represent day after tomorrow. The ‘EffStartDate’ and ‘EffEndDate’ may represent the effective start date and effective end date for executing the data synchronization model, respectively, to synchronize the data.

In an embodiment, when the data synchronization model is executed successfully, the consistency of the propagation in modification of the data may be determined. The term consistency may correspond to conformity or accuracy of propagating the modifications of the data. The decision logic for determining the consistency of the propagated data may include comparing the data from the table in which data was modified with the data in the other tables. In an embodiment, when the execution of data synchronization model is unsuccessful or fails, a resynchronization model may be executed. For example, the execution of data synchronization model is unsuccessful, when the comparison between the table in which data was modified and the data in the other tables is inconsistent. The term inconsistent may correspond to inaccuracy in propagation of the modifications of the data. In an embodiment, the execution of resynchronization model may propagate the modifications in the data that were unsuccessful.

In an embodiment, the execution of the resynchronization model may determine the datasets that failed to propagate or synchronize the modifications of the data. The decision logic for determining the datasets that failed to synchronize the modifications in the data may include determining the time zones that became effective at a predetermined time (e.g., 00:00 hours); the time intervals (e.g., number of hours or minutes or seconds) between when the time zone became effective (e.g., 00:00 hours) and the last successful synchronization in modifications of the data in the time zone that became effective), etc. For example, a time zone may become effective at midnight (e.g., 00:00 hours) in its respective time zone. Suppose that the scheduled synchronization runs until 01:00 hour and then terminates execution, then the time interval when the time zone became effective and the last successful synchronization in modifications of the data may be determined as 1 hour. Suppose that the next time zone becomes effective at 01:30 hours. Since the scheduler for synchronizing modification is already terminated, it may be determined that the datasets that were associated with the time zone that became effective at 01:30 hours, failed to synchronize or propagate the modifications of the data. In such a scenario, the resynchronization model may be executed to determine the datasets that failed to include the propagated modifications of data and schedule the propagation of modifications in the data. Upon such determination, the resynchronization model may be executed to propagate the modification of the data.

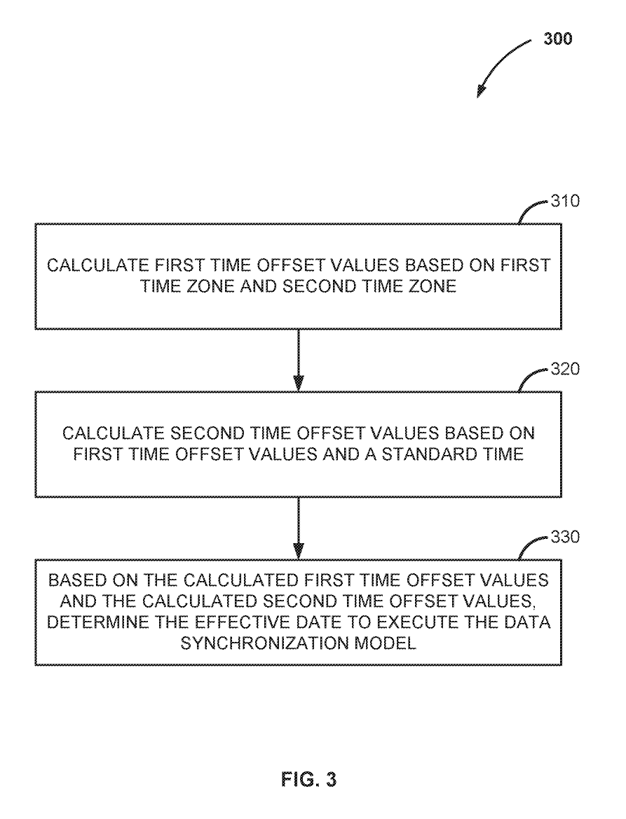

FIG. 3 is a flow diagram illustrating process 300 for executing a time offset model, according to an embodiment. In an embodiment, the time offset values may be calculated by executing the time offset model. First time offset values based on the first time zone and the second time zone are calculated, at 310. Based on the calculated first time offset values and a time standard, second time offset values are calculated at, 320. Based on the first time offset values and the second time offset values, effective date for executing the data synchronization model is determined, at 330.

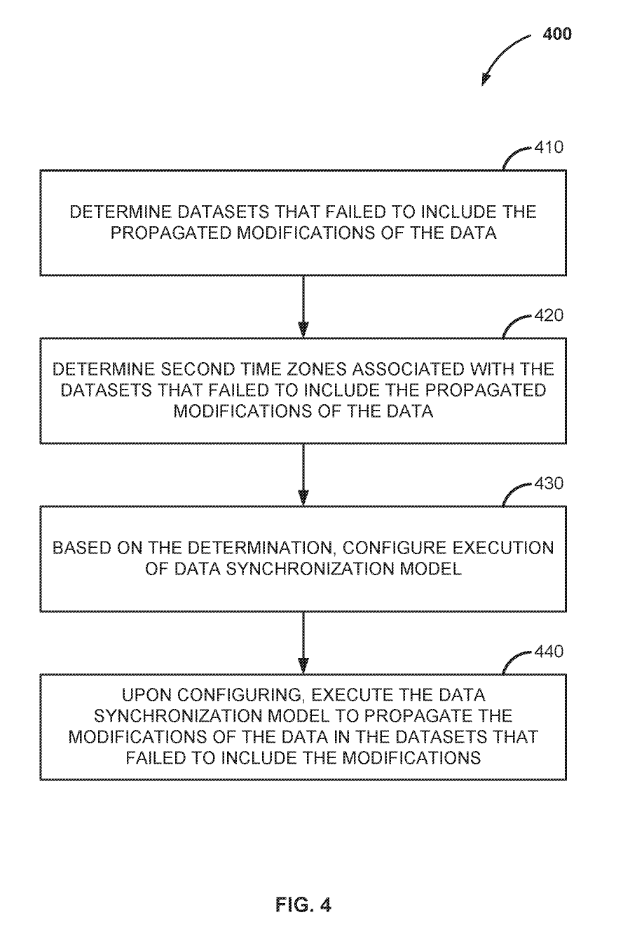

FIG. 4 is a flow diagram illustrating process 400 for executing a resynchronization model, according to an embodiment. In an embodiment, the resynchronization model may be executed to synchronize the modifications of data in datasets that failed to include the propagated modifications. The datasets that failed to include the propagated modifications of business data is determined, at 410. The second time zones associated with the datasets that failed to include the propagated modifications of data is determined, at 420. Based on the determination, the execution of data synchronization model is configured to propagate the modifications of data, in 430. Upon configuring, the data synchronization model is executed to propagate the modifications of data in the datasets that failed to include the propagated modifications, at 440.

In an embodiment, the data synchronization model may be executed at based on decision logic. The decision logic may include executing the data synchronization model predetermined times in a day (e.g., 12:00 hours; 18:00 hours; 00:00 hours, etc.); at periodic intervals of time (e.g., once every hour; once every two hours, etc.); a predetermined number of times on a business day (e.g., once, 3 times, 4 times, etc.). The decision logic to execute the data synchronization model to propagate the modifications of data may be based on business need or business requirements. In an embodiment, the data synchronization model may be automatically executed based on the above described decision logic. In another embodiment, the data synchronization model may be manually executed to synchronize the modifications of data.

In an embodiment, the user interface model may be configured to work in conjunction with the data models (e.g., a data modification model, a time offset model, a data synchronization model, a resynchronization model). When the data modification model determines that data is modified, the user interface model may display the datasets that may be affected by the modifications on a user interface in real-time. As described above, the execution of data synchronization model may filter and aggregate the datasets before synchronizing the modifications of the data. The datasets may be filtered and aggregated based on the determined effective date or time offset values (e.g., positive time offset values, negative time offset values, etc.). In an embodiment, the filtered and aggregated datasets may be displayed on the user interface in real-time.

In an embodiment, the above discussed one or more data models 102 (e.g., a data modification model, a time offset model, a data synchronization model, a resynchronization model, a user interface model, etc.) may be used in various applications in the industry (e.g., inventory management in warehouses, financial information management, logistics management, etc.). Such applications may be deployed and executed on premise computing environment, distributed computing environment (e.g., cloud computing), on portable electronic devices (e.g., smart devices like phones, tablets, personal digital assistant (PDA), etc.).

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs. DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

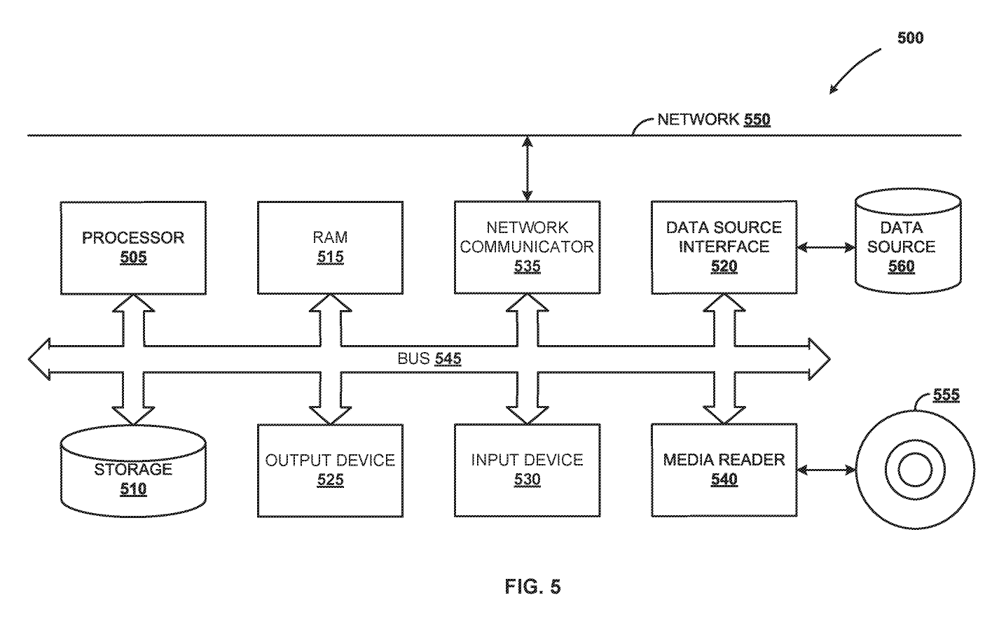

FIG. 5 is a block diagram of an exemplary computer system 500, according to an embodiment. Computer system 500 includes processor 505 that executes software instructions or code stored on computer readable storage medium 555 to perform the above-illustrated methods. The software instructions or code stored on computer readable storage medium 555 may be associated with one or more data models 102 (e.g., a data modification model, a time offset model, a data synchronization model, a resynchronization model, a user interface model, etc.). Processor 505 can include a plurality of cores. Computer system 500 includes media reader 540 to read the instructions from computer readable storage medium 555 and store the instructions in storage 510 or in random access memory (RAM) 515. Storage 510 provides a large space for keeping static data where at least some instructions could be stored for later execution. According to some embodiments, such as some in-memory computing system embodiments, RAM 515 can have sufficient storage capacity to store much of the data required for processing in RAM 515 instead of in storage 510. In some embodiments, all of the data required for processing may be stored in RAM 515. The stored instructions may be further compiled to generate other representations of the instructions and dynamically stored in RAM 515. Processor 505 reads instructions from RAM 515 and performs actions as instructed. According to one embodiment, computer system 500 further includes output device 525 (e.g., a display) to provide at least some of the results of the execution as output including, but not limited to, visual information to users and input device 530 to provide a user or another device with means for entering data and/or otherwise interact with computer system 500. Each of these output devices 525 and input devices 530 could be joined by one or more additional peripherals to further expand the capabilities of computer system 500. Network communicator 535 may be provided to connect computer system 500 to network 550 and in turn to other devices connected to network 550 including other clients, servers, data stores, and interfaces, for instance. The modules of computer system 500 are interconnected via bus 545. Computer system 500 includes a data source interface 520 to access data source 560. Data source 560 can be accessed via one or more abstraction layers implemented in hardware or software. For example, data source 560 may be accessed by network 550. In some embodiments data source 560 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to synchronize data modifications, comprising:
executing, by at least one processor of a computing device, a data modification model, to determine one or more modifications of data in a first table associated with a first time zone;
executing, by the at least one processor, the data modification model, to determine one or more tables for propagating the one or more modifications of the data, the one or more tables associated with one or more second time zones;
based on the first time zone and the one or more second time zones, executing, by the at least one processor, a time offset model, to calculate one or more time offset values; and
based on the calculated one or more time offset values, executing, by the at least one processor, a data synchronization model, to synchronize the one or more modifications of the data in the one or more tables.

2. The computer implemented method of claim 1, wherein executing the time offset model, comprises:
calculating, by the at least one processor, one or more first time offset values based on the first time zone and the one or more second time zones; and
calculating, by the at least one processor, one or more second time offset values based on a time standard and the calculated one or more first time offset values.

3. The computer implemented method of claim 1, wherein executing the time offset model further comprises: determining, by the at least one processor, an effective date to execute the data synchronization model for synchronizing the one or more modifications of the data in the one or more tables.

4. The computer implemented method of claim 3, wherein executing the data synchronization model, further comprises: based on the determined effective date, filtering, by the at least one processor, one or more datasets from the one or more tables for propagating the one or more modifications of the data.

5. The computer implemented method of claim 1, wherein when the execution of the data synchronization model is successful, determining, by the at least one processor, consistency of propagation in the one or more modifications of the data in the one or more tables.

6. The computer implemented method of claim 1, wherein upon determining that the execution of data synchronization model is unsuccessful, executing, by the at least one processor, a resynchronization model to propagate the one or more modifications of the data in the one or more tables.

7. The computer implemented method of claim 6, wherein executing the resynchronization model, comprises:
determining, by the at least one processor, the one or more datasets that failed to include the propagated one or more modifications in the one or more tables;
determining, by the at least one processor, the one or more second time zones associated with the one or more determined datasets that failed to include the propagated one or more modifications in the one or more tables;
based on the determination, configuring, by the at least one processor, the execution of data synchronization model; and
upon configuring, executing, by the at least one processor, the data synchronization model to propagate the one or more modifications in the one or more datasets that failed to include the one or more modifications.

8. A computer system to synchronize data modifications, comprising:
a memory storing computer instructions; and
a processor communicatively coupled with the memory to execute the instructions to perform operations, comprising:
executing a data modification model, to determine one or more modifications of data in a first table associated with a first time zone;
executing the data modification model, to determine one or more tables for propagating the one or more modifications of the data, the one or more tables associated with one or more second time zones;
based on the first time zone and the one or more second time zones, executing a time offset model, to calculate one or more time offset values; and
executing a data synchronization model, to synchronize the one or more modifications of the data in the one or more tables.

9. The computer system of claim 8, wherein executing the time offset model, comprises:
calculating one or more first time offset values based on the first time zone and the one or more second time zones; and
calculating one or more second time offset values based on a time standard, and the calculated one or more first time offset values.

10. The computer system of claim 8, wherein executing the time offset model, further comprises: determining an effective date to execute the data synchronization model for synchronizing the one or more modifications of the data in the one or more tables.

11. The computer system of claim 10, wherein executing the data synchronization model, further comprises: based on the determined effective date, filtering, by the at least one processor, one or more datasets from the one or more tables for propagating the one or more modifications of the data.

12. The computer system of claim 8, wherein when the execution of the data synchronization model is successful, determining consistency of propagation in the one or more modifications of the data in the one or more tables.

13. The computer system of claim 8, wherein upon determining that the execution of data synchronization model is unsuccessful, executing a resynchronization model to propagate the one or more modifications of the data in the one or more tables.

14. The computer system of claim 13, wherein executing the resynchronization model, comprises:
determining the one or more datasets that failed to include the propagated one or more modifications in the one or more tables;
determining the one or more second time zones associated with the one or more determined datasets that failed to include the propagated one or more modifications in the one or more tables;
based on the determination, configuring the execution of data synchronization model; and
upon configuring, executing the data synchronization model to propagate the one or more modifications in the one or more datasets that failed to include the one or more modifications.

15. A non-transitory computer readable storage medium tangibly storing instructions, which when executed by a computer, cause the computer to execute operations, comprising:
executing a data modification model, to determine one or more modifications of data in a first table associated with a first time zone;
executing the data modification model, to determine one or more tables for propagating the one or more modifications of the data, the one or more tables associated with one or more second time zones;
based on the first time zone and the one or more second time zones, executing a time offset model, to calculate one or more time offset values; and
executing a data synchronization model, to synchronize the one or more modifications of the data in the one or more tables.

16. The non-transitory computer readable storage medium of claim 15, wherein executing the time offset model, comprises:
calculating one or more first time offset values based on the first time zone and the one or more second time zones; and
calculating one or more second time offset values based on a time standard, and the calculated one or more first time offset values.

17. The non-transitory computer readable storage medium of claim 15, wherein executing the time offset model further comprises: determining an effective date to execute the data synchronization model for synchronizing the one or more modifications of the data in the one or more tables.

18. The non-transitory computer readable storage medium of claim 15, wherein based on the determined effective date, filtering, by the at least one processor, one or more datasets from the one or more tables for propagating the one or more modifications of the data.

19. The non-transitory computer readable storage medium of claim 15, wherein upon determining that the execution of data synchronization model is unsuccessful, executing a resynchronization model to propagate the one or more modifications of the data in the one or more tables.

20. The non-transitory computer readable storage medium of claim 19, wherein executing the resynchronization model, comprises:
determining the one or more datasets that failed to include the propagated one or more modifications in the one or more tables;
determining the one or more second time zones associated with the one or more determined datasets that failed to include the propagated one or more modifications in the one or more tables;
based on the determination, configuring the execution of data synchronization model; and
upon configuring, executing the data synchronization model to propagate the one or more modifications in the one or more datasets that failed to include the one or more modifications.
